(19) United States
(12) Patent Application Publication
(10) Pub. No.: US 2013/0080806 A1
(43) Pub. Date: Mar. 28, 2013

(54) MEDIA PROCESSING DEVICE AND METHOD OF CONTROLLING A MEDIA PROCESSING DEVICE

(71) Applicant: Hisakazu Koyama, Nagano-shi (JP)

(72) Inventor: Hisakazu Koyama, Nagano-shi (JP)

(73) Assignee: Seiko Epson Corporation, Tokyo (JP)

(21) Appl. No.: 13/613,911

(22) Filed: Sep. 13, 2012

(30) Foreign Application Priority Data
Sep. 27, 2011 (JP) 2011-210480

(51) Int. Cl. G06F 1/32

(52) U.S. Cl. 713/320

(57) ABSTRACT

Power consumption is reduced without reducing convenience in a media processing device having a programmable device that requires configuration. The media processing device has a plurality of control devices, at least one control device is a CPU 101, and at least one control device is a programmable device that requires configuration when the power turns on, such as a FPGA 104. The CPU 101 executes a power supply control process based on specific conditions to set the FPGA 104, which is a programmable control device, and the CPU 101, which is one of the control devices, to a sleep mode in stages. The CPU 101 can also change the transition time for setting the FPGA 104 to the sleep mode after the specific condition is met in the power supply control process.

This application claims priority under 35 U.S.C. §119 to Japanese Patent Application No. 2011-210480 filed on Sep. 27, 2011, the entire disclosure of which is expressly incorporated by reference herein.

### BACKGROUND

1. Technical Field

The present invention relates to a media processing device and a method of controlling a media processing device.

2. Related Art

Media processing devices such as printers that process printing paper and other media for processing (“processed media”), and have a mode such as a sleep mode in which the power supply to parts such as the system controller is stopped to reduce power consumption during idle time (standby time), are known from the literature. See, for example, Japanese Unexamined Patent Appl. Pub. JP-A-2010-94925. The media processing device described in JP-A-2010-94925 starts energizing the system controller and resumes the normal operating mode when a request from an external host computer is received while power supply to the system controller is stopped.

Programmable logic devices (PLD) such as field-programmable gate arrays (FPGA) are increasingly used as device controllers in such media processing devices. Many PLDs must be configured during startup by loading a program and data from ROM and setting the circuit data enabling the PLD to operate. Because this circuit data is volatile, the data is cleared when power supply to the PLD stops. Configuration is therefore required when the power supply resumes, creating a delay until configuration is completed, requiring more time to resume the normal operating mode, and possibly inconveniencing the user.

### SUMMARY

A media processing device having a programmable device such as a PLD that requires configuration can reduce power consumption without reducing convenience.

A media processing device according to one aspect of the invention has a plurality of control devices, at least one control device is a CPU (central processing unit), and at least one control device is a programmable device that requires configuration. The CPU executes a power supply control process that sets the programmable device and the other control device including the CPU in stages to a sleep mode based on a specific condition; and the CPU can change the transition time of the power supply control process for setting the programmable device to the sleep mode after the specific condition is met.

When data is not received for a specific time from an external device, or a specific time passes after a media processing operation ends, this aspect of the invention can reduce power consumption while idle by setting the control devices to a sleep mode based on specific conditions. Programmable devices that require configuration can be set to the sleep mode in stages separately from other control devices. For example, by setting the programmable device to the sleep mode at a later time than the CPU and other control devices when the programmable device receives data from the external device, data can be received from the external device as long as possible before the programmable device goes to sleep, and the frequency that the programmable device enters the sleep mode can be reduced. The delay required for configuration when the programmable device resumes normal operation can therefore be reduced, operation can be resumed from the sleep mode more quickly after part of the CPU or control device enters the sleep mode, and power consumption can be reduced without reducing convenience.

In another aspect of the invention, a first sleep mode that is applied to the programmable device in the power supply control process is a mode in which the CPU stops supplying power to the programmable device, and a second sleep mode that is applied to the control device including the CPU other than the programmable device is a mode in which the CPU intermittently supplies power to the control device, or supplies power to one module and does not supply power to another module of the control device.

This aspect of the invention separately controls the sleep mode of the programmable device and the sleep mode of the other control devices, stopping the power supply in the first sleep mode applied to the programmable device, and supplying power intermittently or only to a selected module and not to other modules of the control device in the second sleep mode applied to the CPU and other control devices. Because the CPU and other control devices are set to the sleep mode for a specific time or only partially, the CPU can resume operation quickly from the sleep mode, and can control returning the programmable device to normal operation. In addition, because sleep modes that differ conditionally are set in stages, and the power supply to the programmable device stops when in the sleep mode, power consumption can be reduced in stages in addition to waking quickly from the sleep mode.

A media processing device according to another aspect of the invention preferably also has an interface unit that can connect to an external device; and the CPU sets the transition time of the power supply control process for setting the programmable device to the sleep mode after the specific condition is met based on a command received through the interface unit.

This aspect of the invention can set the transition time of the power supply control process for setting the programmable device to the sleep mode after the specific condition is met based on a command from an external device. Because how frequently the sleep mode is entered can therefore be adjusted, how frequently configuration of the programmable device is required can be easily adjusted. The balance between suppressing power consumption and the time required to recover from the sleep mode can therefore be easily optimized to how the media processing device is used, and convenience can be improved.

In a media processing device according to another aspect of the invention, in the power supply control process the CPU changes between a plurality of stages including a first stage that sets the control device including the CPU other than the programmable device to the sleep mode, and a second stage that sets the programmable device to the sleep mode.

The stage for setting the programmable device to the sleep mode is controlled to be clearly separate from the stage for setting other control devices to the sleep mode. As a result, the condition (such as the transition time) for setting the programmable device to the sleep mode can be set separately from the condition (such as the transition time) for the CPU going to sleep, and how frequently configuration is required can be adjusted as desired.

In a media processing device according to another aspect of the invention, the CPU has a plurality of processing units that process media to be processed; at least one of the processing units operates as controlled by the programmable device; and in the power supply control process, the CPU enters a stage that stops power supply to at least one processing unit before entering the sleep mode of the first stage, and enters the sleep mode of the first stage thereafter.

In this case, by providing a stage for stopping power supply to processing units such as the conveyance unit that conveys media, reading units that read information on the conveyed media, and recording units that print or record on the conveyed media, in addition to the stage for setting the programmable device to the sleep mode and the stage for setting other control devices to the sleep mode, the power supply can be preferentially stopped to processing units that have high current consumption, such as the hold current of the motors used in these processing units, while idle and take little time to resume operation after the power supply stops, power consumption can be further suppressed, and how frequently the programmable device must be configured can be adjusted desirably.

Another aspect of the invention is a method of controlling a media processing device having a plurality of control devices including a programmable device that requires configuration and a CPU, the control method having steps of: executing a power supply control process that sets the programmable device and the other control device including the CPU in stages to a sleep mode based on a specific condition; and changing the transition time for setting the programmable device to the sleep mode after the specific condition is met in the power supply control process.

When data is not received for a specific time from an external device, or a specific time passes after a media processing operation ends, this aspect of the invention can reduce power consumption while idle by setting the control devices to a sleep mode based on specific conditions. Programmable devices that require configuration can be set to the sleep mode in stages separately from other control devices. For example, by setting the programmable device to the sleep mode at a later time than the CPU and other control devices when the programmable device receives data from the external device, data can be received from the external device as long as possible before the programmable device goes to sleep, and the frequency that the programmable device enters the sleep mode can be reduced. The delay required for configuration when the programmable device resumes normal operation can therefore be reduced, operation can be resumed from the sleep mode more quickly after part of the CPU or control device enters the sleep mode, and power consumption can be reduced without reducing convenience.

### EFFECT OF THE INVENTION

By reducing the delay time required for configuration after a programmable device resumes operation from the sleep mode, this aspect of the invention enables the media processing device to quickly resume operation from the sleep mode and suppress power consumption without reducing convenience.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a media processing device according to a preferred embodiment of the invention.

FIG. 2 is a plan view of the media processing device.

FIG. 3 is a block diagram of media processing system.

FIG. 4 is a flow chart of the operation of the media processing device.

FIG. 5 is a flow chart of the operation of the media processing device.

### DESCRIPTION OF EMBODIMENTS

A preferred embodiment of the present invention is described below with reference to the accompanying figures.

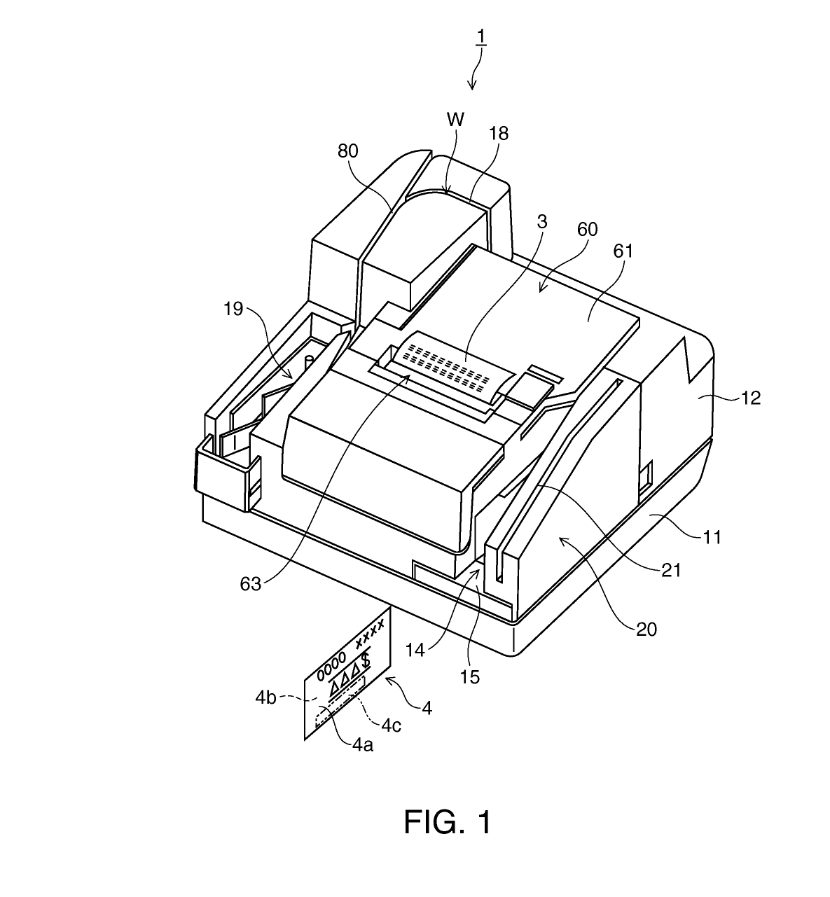

FIG. 1 is an oblique view of a media processing device 1 according to this embodiment of the invention.

As shown in FIG. 1, the media processing device 1 is a device that can process media such as checks and other forms (referred to herein as “processed media”) in multiple ways, including reading magnetic ink characters printed on the processed medium, optically imaging (scanning) both sides of the processed medium, and recording (printing) images including text on the processed medium. The media processing device 1 also functions as a card reader that reads magnetic information recorded on card media such as credit cards, and functions to produce specific types of tickets with an image recorded thereon by recording an image to thermal roll paper 3 and cutting the paper.

This embodiment of the invention describes processing checks 4 (first processed medium) and thermal roll paper 3 (second processed medium) as examples of processed media.

As shown in FIG. 1, a check 4 is a form having a payment amount, payee, serial number, payer signature, and other information printed on a sheet (paper) with a specific colored or patterned background. The payment amount, payee, serial number, payer signature, and other information are printed on the face 4a, and an endorsement area is provided on the back 4b. An endorsement is printed with specific text or an image in the endorsement area by the inkjet head 10 described below. An MICR (magnetic ink character recognition) line 4c is preprinted along the length of the check 4 on the face 4a. The MICR line 4c is a line of magnetic ink characters printed with magnetic ink, and can be read magnetically and optically.

The roll paper 3 is thermal paper that changes color when heat is applied, and the media processing device 1 records text and images by applying heat to the recording side of the roll paper 3 with a thermal printer unit 60.

The outside case of the media processing device 1 includes a bottom case 11 that covers the bottom part of the media processing device 1, and a cover 12 that covers the bottom case 11, and the main unit of the media processing device 1 is housed inside this outside case. An entrance 14 for inserting checks 4 is open at the front of the media processing device 1, and a stacker 15 that can hold a stack of plural checks 4 is provided inside the entrance 14. The stacker 15 can be pulled out to the front, and the checks 4 can be loaded into the stacker 15 after adjusting the stacker 15 to the size of the checks 4 to be stored in the stacker 15.

A slot 18 that is substantially U-shaped when seen from above and is used as the conveyance path W of the checks 4 is formed in the cover 12, and the slot 18 ends in an exit pocket 19 at the front of the media processing device 1. Checks 4 stored in the stacker 15 are fed one by one into the media processing device 1 as described below, are processed as they pass through the slot 18, and the processed checks 4 are discharged into the exit pocket 19. Multiple checks 4 can accumulate in the exit pocket 19.

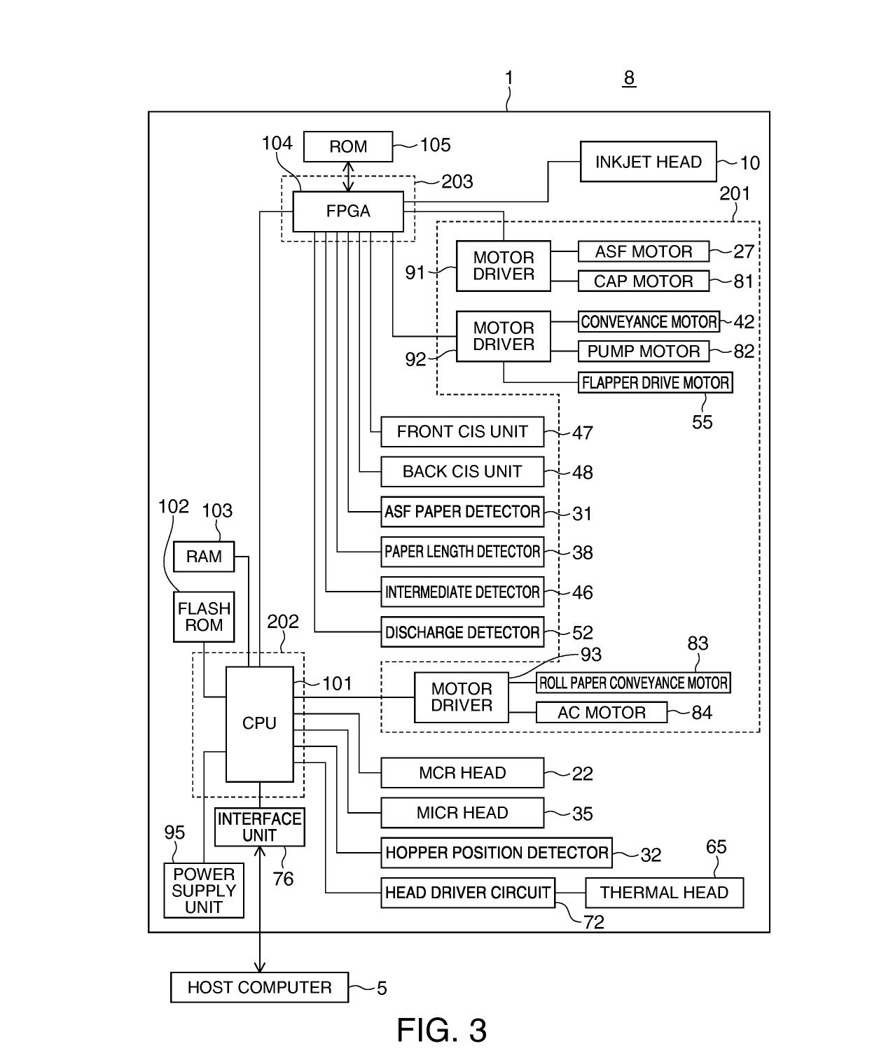

As shown in FIG. 1, a magnetic card reader 20 is disposed beside the stacker 15. The magnetic card reader 20 includes a card slot 21 formed in the cover 12, and a MCR (magnetic card reader) head 22 (FIG. 3) disposed facing the card slot 21, and reads information magnetically recorded on cards passing through the card slot 21 with the MCR head 22.

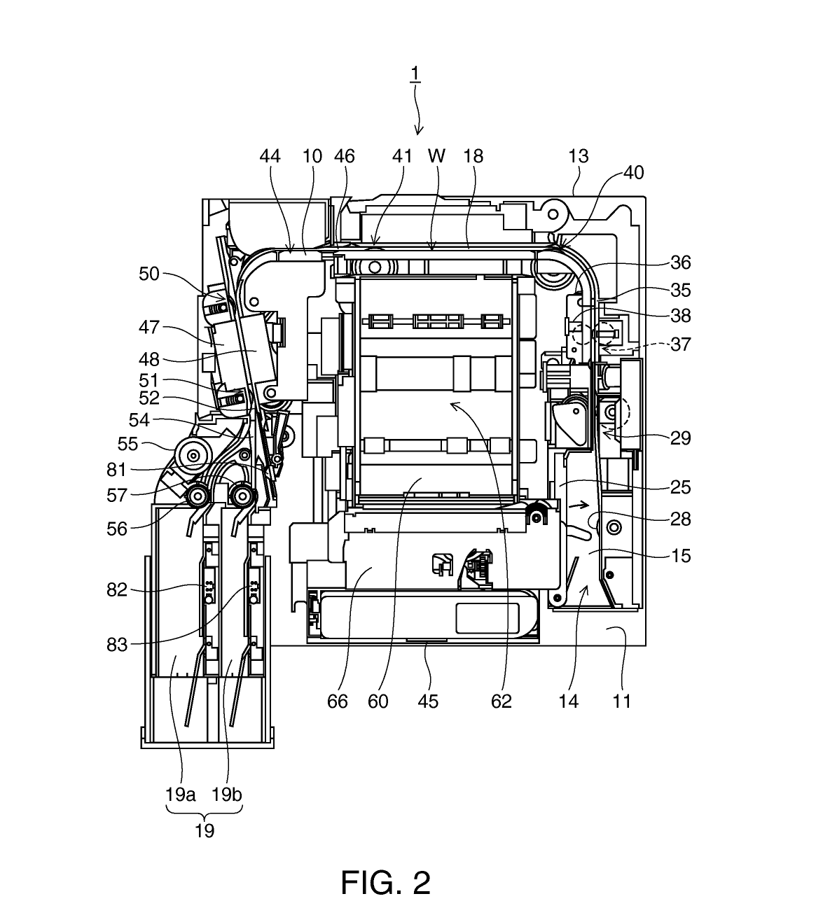

FIG. 2 is a plan view showing the configuration of the main unit of the media processing device 1 housed the outside case. As shown in FIG. 2, a hopper 25 is disposed on one side of the stacker 15. The hopper 25 can pivot in the direction of the arrow, is moved by power from an ASF motor 27, and pushes the checks 4 in the stacker 15 to the other side.

A pickup roller 28 driven by an ASF (automatic sheet feeder) motor 27 (FIG. 3) described below is disposed on the other side of the stacker 15, and when the hopper 25 rotates toward the pickup roller 28, one check 4 in the stacker 15 is urged by the rotating hopper 25 to the pickup roller 28, contacts the roller, and is fed into the conveyance path W by rotation of the pickup roller 28.

An ASF roller set 29 composed of a pair of rollers is disposed downstream from the stacker 15. The two rollers of the ASF roller set 29 are disposed on opposite sides of the conveyance path W, one roller is driven by the ASF motor 27, and the other roller is a follower roller. The check 4 in contact with the pickup roller 28 is nipped by the ASF roller set 29, and conveyed downstream through the slot 18.

An ASF paper detector 31 (FIG. 3) is disposed to a specific position in the stacker 15. The ASF paper detector 31 is a transmissive photosensor in this embodiment, and detects if a check 4 is in the stacker 15.

A hopper position detector 32 (FIG. 3) is disposed at the standby position of the hopper 25 in the stacker 15. The hopper position detector 32 is a transmissive photosensor in this embodiment, and detects if the hopper 25 is in the standby position.

A MICR (magnetic ink character recognition) head 35 that contacts the face 4a of the check 4 and magnetically reads the MICR line 4c (FIG. 1) is disposed downstream from the ASF roller set 29. A MICR roller 36 is disposed opposite the MICR head 35. The MICR roller 36 is pushed to the MICR head 35 side, rotates while pressing the check 4 against the MICR head 35, and conveys checks 4 at a constant speed suited to reading the MICR line. An assist roller set 37 composed of a pair of rollers that guide the check 4 fed by the ASF roller set 29 to the MICR head 35 is disposed on the upstream side of the MICR head 35.

A paper length detector 38 is disposed to the conveyance path W between the assist roller set 37 and MICR head 35. The paper length detector 38 is a reflective photosensor in this embodiment, and detects the leading end and trailing end of each check 4 by detecting if a check 4 passing through the conveyance path W is at the detection position. The control unit 70 (control unit) acquires the output signals of the paper length detector 38 and determines the length of the check 4 based on change in detector output.

A first conveyance roller set 40 including a pair of rollers disposed on opposite sides of the conveyance path W is disposed to the conveyance path W on the downstream side of the MICR head 35, and a second conveyance roller set 41 is disposed downstream from the first conveyance roller set 40. The first conveyance roller set 40 and second conveyance roller set 41 are driven rotationally by a conveyance motor 42 (FIG. 3), and these rollers convey the check 4 to the inkjet printer unit 44 (print unit).

The inkjet printer unit 44 has an inkjet head 10 (inkjet recording head). The inkjet head 10 is an inkjet recording head that is supplied with ink from an ink cartridge 45 (ink storage unit) installed in the front part of the media processing device 1 and ejects ink onto the check 4. The inkjet head 10 in this embodiment prints an endorsement including text or symbols on the back 4b of the check 4.

A cap (not shown in the figure) is disposed in front of the inkjet head 10 with the conveyance path W therebetween. The cap can move to and away from the inkjet head 10 side as driven by a cap motor 81 (FIG. 3), and advances to the inkjet head 10 side and covers the nozzle face of the inkjet head 10 when a check 4 is not being processed to prevent the ink from drying. A hole for suctioning ink is disposed inside the cap, and this hole communicates with a suction pump not shown.

The suction pump is driven by a pump motor 82 (FIG. 3), and suctions ink from the nozzles of the inkjet head 10 through the cap when a cleaning operation for solving ejection problems in the nozzles of the inkjet head 10 is performed Ink removed by the suction pump is stored in a waste ink tank (not shown in the figure).

An intermediate detector 46 is disposed between the inkjet head 10 and second conveyance roller set 41. The intermediate detector 46 is a reflective photosensor in this embodiment, and detects if a check 4 is at the detection position.

A CIS (contact image sensor) unit for optically reading checks 4 is disposed downstream from the inkjet head 10. This CIS unit includes a front CIS unit 47 for imaging the face 4a of the check 4, and a back CIS unit 48 for imaging the back 4b, and can thus optically image both sides of each check 4. The front CIS unit 47 and back CIS unit 48 are disposed on opposite sides of the conveyance path W. A first CIS roller 50 is disposed on the upstream side and a second CIS roller 51 is disposed on the downstream side of these units. The first CIS roller 50 and second CIS roller 51 are rollers that are driven rotationally by the conveyance motor 42, and checks 4 are conveyed by these rollers at a constant speed while being imaged by the CIS units.

A discharge detector 52 is located downstream from the second CIS roller 51. The discharge detector 52 is a reflective photosensor in this embodiment, and detects if a check 4 is at the detection position.

The exit pocket 19 described above is located downstream from the front CIS unit 47 and back CIS unit 48. The exit pocket 19 is divided into a main pocket 19a and a sub-pocket 19b, and the slot 18 splits and is connected to both the main pocket 19a and sub-pocket 19b. The main pocket 19a and sub-pocket 19b can each hold a plurality of checks 4.

A flapper 54 that switches the exit pocket 19 into which the check 4 is discharged to the main pocket 19a or sub-pocket 19b is disposed at the position where the slot 18 splits. The flapper 54 is a guide that by closing the path to the main pocket 19a or the path to the sub-pocket 19b guides the check 4 into the other pocket, and is driven by the flapper drive motor 55.

A discharge roller 56 is disposed to the path from the flapper 54 to the main pocket 19a, another discharge roller 57 is disposed to the path from the flapper 54 to the sub-pocket 19b, and the checks 4 are thus smoothly discharged by these rollers and guided by the flapper 54 into the appropriate exit pocket 19.

As described below, the media processing device 1 discharges the check 4 into the main pocket 19a when the check 4 is determined to have been correctly loaded based on the result of the MICR head 35 reading the MICR line 4c, and into the sub-pocket 19b when the check 4 is determined to have not been correctly loaded.

As shown in FIG. 1 and FIG. 2, a thermal printer unit 60 is disposed in the middle of the media processing device 1.

A shown in FIG. 1, the thermal printer unit 60 has a printer cover 61 covering the top of the media processing device 1. This printer cover 61 is attached to the cover 12 so that the printer cover 61 can open and close freely. When the printer cover 61 is open, a roll paper compartment 62, which is a space for holding roll paper 3, is exposed and the roll paper 3 can be installed or replaced. A paper exit 63 is formed in the printer cover 61, and the roll paper 3 held in the roll paper compartment 62 can be discharged through the paper exit 63.

The thermal printer unit 60 includes a roller platen (not shown in the figure) that supplies and feeds roll paper 3 stored in the roll paper compartment 62, a thermal head 65 (FIG. 3) disposed opposite the platen, and a cutter unit 66 that cuts the roll paper 3 perpendicularly to the conveyance direction. To produce a ticket, the platen of the thermal printer unit 60 is driven rotationally by power from the roll paper conveyance motor 83 (FIG. 3) and conveys the roll paper 3 in the conveyance direction. The cutter unit 66 has a movable knife (not shown in the figure) that operates with power from the AC (auto cutter) motor 84, and a fixed knife (not shown in the figure), and cuts the roll paper 3 by the cutting action of the movable knife and fixed knife with the roll paper 3 therebetween. The thermal printer unit 60 records characters and images on the roll paper 3 with the thermal head 65 while rotating the platen and conveying the roll paper 3, and then cuts the roll paper 3 at a specific position with the cutter unit 66, producing a ticket. This ticket is a transaction record (receipt) related to a transaction using a check 4, for example.

FIG. 3 is a block diagram showing the functional configuration of a media processing system 8 composed of the media processing device 1 connected to a host computer 5 as an external device.

As shown in FIG. 3, the media processing device 1 has a CPU 101 and a FPGA 104 as control devices that control the media processing device 1. The CPU 101 reads and writes a program stored in flash ROM 102 to RAM 103, and controls parts of the media processing device 1 including the FPGA 104. The FPGA 104 is a programmable device that performs the operations set in a programming file stored in ROM 105, and controls other parts as described below.

The media processing device 1 also has a power supply unit 95 that converts an externally supplied voltage and supplies power to the parts of the media processing device 1. The power supply unit 95 has a function that changes the supply state of the power supply to other parts of the media processing device 1 as controlled by the CPU 101. For example, the CPU 101 controls supplying power from the power supply unit 95 to the motor drivers 91, 92, 93, and controls supplying power to motors including the ASF motor 27, cap motor 81, conveyance motor 42, pump motor 82, flapper drive motor 55, roll paper conveyance motor 83, and AC motor 84 to not exceed the power supply capacity of the power supply unit 95. The CPU 101 also executes a power conservation control process (power supply control process) described below and switches the power supply from the power supply unit 95 to other parts on/off based on the operating state of the media processing device 1 to suppress power consumption when the media processing device 1 is idle.

Connected to the CPU 101 are flash ROM 102 that stores programs run by the CPU 101 and data related to the programs, and RAM 103 that temporarily stores the programs run by the CPU 101 and related data.

ROM 105 that stores the programming file (configuration data) of the FPGA 104 is connected to the FPGA 104.

The FPGA 104 runs a configuration process when power supply from the power supply unit 95 starts.

This configuration process includes the following steps, and is executed every time the power supply from the power supply unit 95 to the FPGA 104 switches from off to on.
Checking the power supply voltage from the power supply unit 95
Running an initialization process including initializing internal memory
Detecting the programming file stored in ROM 105
Loading the detected programming file from ROM 105
Writing circuit data according to the loaded programming file

The inkjet head 10 is connected to the FPGA 104. The CPU 101 writes a print image of the text and images to be printed to RAM 103 according to a command from the host computer 5, and generates and outputs data for ejecting ink from the nozzles of the inkjet head 10 based on the print image to the FPGA 104. The FPGA 104 operates the inkjet head 10 based on the ink ejection data input from the CPU 101, and ejects ink from the inkjet head 10 onto the check 4 to print.

Motor drivers 91, 92 are connected to the FPGA 104, and the FPGA 104 controls the motor drivers 91, 92 based on control data input from the CPU 101. The motor driver 91 is connected to the ASF motor 27 and cap motor 81, supplies drive current to the ASF motor 27 and cap motor 81 as controlled by the FPGA 104, and drives the motors in the direction, speed, and amount specified by the FPGA 104. The other motor driver 92 supplies drive current to the conveyance motor 42 that drives the rollers that convey the checks 4, and to the pump motor 82 and flapper drive motor 55, and drives the motors in the direction, speed, and amount specified by the FPGA 104.

The front CIS unit 47 and back CIS unit 48 are connected to the FPGA 104.

The FPGA 104 images the face 4a and back 4b of the check 4 with the front CIS unit 47 and back CIS unit 48 according to control data from the CPU 101. The FPGA 104 then digitizes the signals output from the front CIS unit 47 and back CIS unit 48, and outputs the digitized data to the CPU 101.

Detectors including the ASF paper detector 31, paper length detector 38, and intermediate detector 46 are also connected to the FPGA 104. The FPGA 104 outputs detection pulses to the ASF paper detector 31, paper length detector 38, and intermediate detector 46, and acquires output signals from the detectors at specific periods.

The FPGA 104 digitizes the output values acquired from the detectors, determines if a check 4 is in the stacker 15, if a check 4 is detected by the paper length detector 38, and if a check 4 is detected by the intermediate detector 46 by comparing the digitized detector values with predetermined threshold values for each detector, and stores the results in an internal register (not shown). The CPU 101 reads the detection result data for each detector stored in the register of the FPGA 104 at specific times.

Motor driver 93 is connected to the CPU 101. This motor driver 93 supplies drive current to the roll paper conveyance motor 83 that drives the platen to convey the roll paper 3, and the AC motor 84 that operates the movable knife (not shown in the figure) of the cutter unit 66, and drives these motors in the direction, speed, and amount specified by the CPU 101.

The MCR head 22 and MICR head 35 are connected to the CPU 101. The CPU 101 causes the MCR head 22 to read the magnetic information when a card is swiped through the card slot 21 (FIG. 1), and detects the read signal output from the MCR head 22.

The CPU 101 also reads magnetic information recorded on a check 4 with the MICR head 35, and detects the output signal from the MICR head 35.

The hopper position detector 32 is also connected to the CPU 101, and the CPU 101 determines if the hopper 25 is in the standby position by outputting a detection pulse to the hopper position detector 32 and getting the output signal from the hopper position detector 32.

The head driver circuit 72 that drives the thermal head 65 is also connected to the CPU 101. The head driver circuit 72 controls energizing the heat elements of the thermal head 65 and prints characters and images on the roll paper 3 with the thermal head 65 as controlled by the CPU 101.

An interface unit 76 that is connected to the host computer 5 by wire or wirelessly is also connected to the CPU 101. The CPU 101 controls the interface unit 76 to exchange data, including control data, with the host computer 5. The CPU 101 tries receiving a command sent from the host computer 5 at a regular period with the interface unit 76 so that commands sent from the host computer 5 can be quickly received.

The CPU 101 receives a process control command sent from the host computer 5 and processes a check 4 accordingly.

The CPU 101 determines if a check 4 is in the stacker 15 based on the result of evaluating the output of the ASF paper detector 31 according to the check 4 processing command. If a check 4 is in the stacker 15, the CPU 101 checks if the hopper 25 is in the standby position based on the output of the hopper position detector 32, operates the ASF motor 27 through the FPGA 104, and picks and feeds one check 4 into the conveyance path W.

Next, the CPU 101 controls the FPGA 104 to operate the conveyance motor 42, operates the ASF roller set 29, MICR roller 36, assist roller set 37, first conveyance roller set 40, second conveyance roller set 41, first CIS roller 50, second CIS roller 51, and discharge rollers 56, 57, and conveys the check 4.

The CPU 101 also controls the FPGA 104 to operate the flapper drive motor 55, move the flapper 54 and set the output pocket of the processed check 4 to the main pocket 19a or sub-pocket 19b, and discharges the check 4 with the discharge rollers 56, 57.

The roll paper conveyance motor 83, AC motor 84, and motor driver 93 that operate as controlled by the CPU 101 function as a conveyance unit. The ASF motor 27, conveyance motor 42, and motor drivers 91, 92 that operate as controlled by the FPGA 104 also function as a conveyance unit (first conveyance unit).

The CPU 101 reads with the MCR head 22 according to a command to read the MICR line 4c of the check 4, acquires and recognizes the magnetic waveform or data output from the MCR head 22, and outputs the recognition result to the host computer 5.

Based on a command for printing a check 4 and the print data sent with the print command, the CPU 101 generates a print image of the text and images to be recorded, and prints the text and images in the print image on the face 4a or back 4b of the check 4 with the inkjet head 10 by controlling the FPGA 104.

The CPU 101 also controls the FPGA 104 according to a command for optically scanning the check 4 to read the face 4a and back 4b of the check 4 with the front CIS unit 47 and back CIS unit 48, and outputs the captured image data input from the FPGA 104 to the host computer 5.

If a command to print on the roll paper 3 is received from the host computer 5, CPU 101 generates and buffers a print image of the text and images to be recorded. The CPU 101 then controls the motor driver 93 to drive the roll paper conveyance motor 83 and convey the roll paper 3 with the platen, and controls the head driver circuit 72 to print text and images based on the print image to the roll paper 3 with the thermal head 65. After printing, the CPU 101 operates the AC motor 84 with the motor driver 93, and cuts the roll paper 3 with the cutter unit 66.

The motor driver 93 and roll paper conveyance motor 83 that conveys the roll paper 3 as controlled by the CPU 101 function as a conveyance unit (second conveyance unit).

The CPU 101 controls switching between the motor drivers 91, 92, 93 connected to the power supply unit 95 based on whether the media processing device 1 is to process roll paper 3 or process a check 4 based on the command received from the host computer 5. Depending upon the specifications of the power supply unit 95, for example, operating the plural motors driven by the motor drivers 91, 92, 93 of the media processing device 1 could exceed the rated capacity of the power supply unit 95. If the power supply unit 95 is connected to all of the motor drivers 91, 92, 93 in this case, the motors connected to each of the drivers could operate at the same time and the load could exceed the rated capacity.

The CPU 101 therefore controls appropriately switching between the motor drivers connected to the power supply unit 95 according to the amount of power that the power supply unit 95 can supply. In this embodiment the CPU 101 controls exclusively connecting motor drivers 91, 92 or motor driver 93 to the power supply unit 95. More specifically, the CPU 101 evaluates the command received from the host computer 5, supplies power from the power supply unit 95 to motor driver 93 if roll paper 3 is processed, and supplies power from the power supply unit 95 to motor drivers 91, 92 if a check 4 is processed.

The CPU 101 also applies power conservation control based on the operating state of the media processing device 1. Power conservation control is applied when the media processing device 1 is not processing roll paper 3 or a check 4, is not functioning as a reader to read magnetic information magnetically recorded on a card with the MCR head 22, and is waiting to receive a command from the host computer 5.

The media processing device 1 enters a power conservation state that turns power supply to parts of the media processing device 1 off when in this standby mode. More specifically, the power conservation state in the media processing device 1 according to this embodiment of the invention is set in two stages, a first power conservation state (level 1) and a second power conservation state (level 2). The time for going from the normal standby mode to the first power conservation state, and the time for going from the first power conservation state to the second power conservation state, are previously stored in flash ROM 102. The CPU 101 controls switching to these power conservation states according to the settings stored in flash ROM 102.

Power supply control is applied to the power control group 201 including motor drivers 91, 92, 93 and the motors connected thereto as shown in FIG. 3, and power control group 202 composed of the CPU 101, in the first power conservation state. In the second power conservation state, power supply control is applied to the power control group 203 consisting of the FPGA 104 in addition to power control groups 201 and 202. Note that motors not shown in FIG. 3 may also be included in power control group 201. Because the motor drivers 91, 92, 93 consume power even in the standby mode while power is supplied from the power supply unit 95, power consumption while idle can be saved by entering the first and second power conservation states appropriately. Note that while the power control groups 201 and 202 are a processing unit in this embodiment of the invention, the inkjet head 10 (recording unit), MICR head 35 (reading unit), front CIS unit 47 (reading unit), back CIS unit 48 (reading unit), and thermal head 65 (recording unit) may also be included in the processing unit.

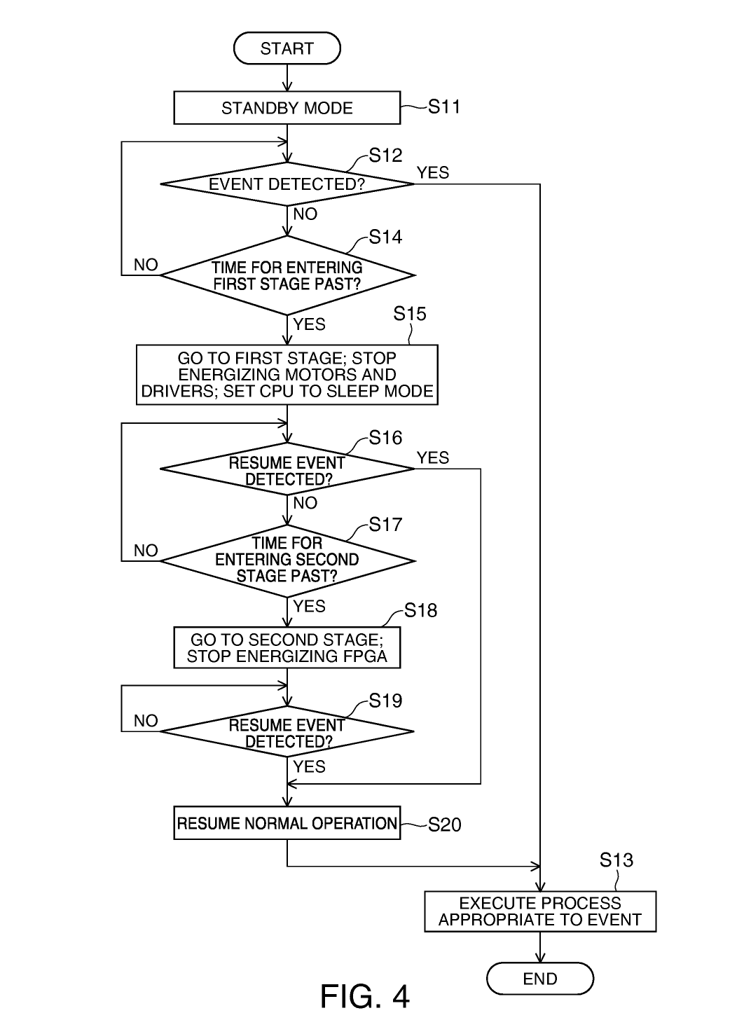

FIG. 4 is a flow chart of the operation of the media processing device 1, and more particularly describes power conservation control by the CPU 101.

The CPU 101 counts the time from when the media processing device 1 entered the standby mode using an internal timer (not shown in the figure) (step S11), and monitors the occurrence of events (step S12). An event as used here could be the interface unit 76 receiving a command sent from the host computer 5, operation of a switch on the operating panel (not shown in the figure) of the media processing device 1, and opening of the printer cover 61 or cover 12 of the media processing device 1 as detected by a cover detector, such as a switch, (not shown in the figure) connected to the CPU 101.

When an event is detected in the standby mode (step S12 returns Yes), the CPU 101 executes a process appropriate to the detected event (step S13). If an event is not detected in the standby mode (step S12 returns No), the CPU 101 determines if the count of the internal timer has reached the setting of the time for switching to the first power conservation state stored in flash ROM 102 (step S14). If the count has not reached the setting for entering the first power conservation state (step S14 returns No), the CPU 101 returns to the event detection step S12. Steps S12 and S13 are executed on a preset cycle.

If the time past since entering the standby mode has reached the setting for entering the first power conservation state (step S14 returns Yes), the CPU 101 enters the first power conservation state, stops energizing the motor drivers 91, 92, 93, and enters a sleep mode (step S15). By stopping energizing the motor drivers 91, 92, 93, power supply to the motors connected to the motor drivers 91, 92, 93 also stops.

The CPU 101 sleep mode is a mode in which power supply to the CPU 101 is intermittently stopped so that the CPU 101 can detect resume events described below at a specific time interval. In this case, the CPU 101 stores a flag in the flash ROM 102 indicating that the first power conservation state is set, and tries to detect a resume event each time power is supplied from the power supply unit 95 (step S16). More specifically, the CPU 101 gets the output values of the detectors connected to the CPU 101, detects operation of the operating panel, and determines if a command was received from the host computer 5 by the interface unit 76. A resume event is an event defined as a condition for resuming operation from the first power conservation state and second power conservation state described below, and could be the same as the events detected in step S12, or only part of those events. Separate events could also be set as the resume events for waking from the first power conservation state, and the resume events for waking from the second power conservation state. When a detector switch connected to the CPU 101 detects that the printer cover 61 or cover 12 of the media processing device 1 was opened, for example, a configuration that inputs this detection as a control interrupt to the CPU 101 is also conceivable. A configuration in which the CPU 101 separately switches the power supply to a circuit module that detects events and other circuit modules on and off is also conceivable. In this configuration, power is supplied only to the event detection circuit module, and the power supply to other circuit modules is stopped, in the first power conservation state.

Because the power supply to the power control group 201 is stopped in the first power conservation state, power consumption can be reduced compared with the normal operating state (including the standby mode). In addition, because power is supplied intermittently to the CPU 101, or power is supplied only to a particular circuit module and power supply to other circuit modules is stopped, power consumption can be further reduced compared to the normal operating mode.

The CPU 101 also counts the time past from entering the first power conservation state in step S15 with the internal timer. If the time is counted based on the period of intermittent power supply to the CPU 101, the CPU 101 can continue counting the time after entering the sleep mode.

When the CPU 101 detects a resume event after entering the first power conservation state (step S16 returns Yes), the CPU 101 resumes normal operation (step S20). In step S20 the CPU 101 returns the power supply to the power control groups 201 and 202 to the level supplied for normal operation, clears the flag stored in the flash ROM 102 indicating that the first power conservation state is set, returns to step S13, and runs the process appropriate to the event.

If a resume event is not detected (step S16 returns No), the CPU 101 determines if the count of the internal time has reached the transition time stored in flash ROM 102 for going to the second power conservation state (step S17). If the count has not reached the setting for entering the second power conservation state (step S17 returns No), the CPU 101 returns to step S16 to detect a resume event. Steps S16 and S17 are executed on a preset cycle.

If the time past from entering the standby mode has reached the setting for entering the second power conservation state (step S17 returns Yes), the CPU 101 enters the second power conservation state and stops energizing the power control group 202, that is, the FPGA 104 (step S18). As a result, power supply to all power control groups 201 to 203 is stopped. The CPU 101 counts the time past since entering the second power conservation state with the internal timer, stores a flag in flash ROM 102 indicating that the second power conservation state is set, and tries to detect a resume event each time power is supplied from the power supply unit 95 (step S19). When a resume event is detected (step S19 returns Yes), the CPU 101 goes to step S20, returns to the normal operating mode, goes to step S13, and runs the process appropriate to the event.

When a resume event is not detected (step S19 returns No), the CPU 101 repeats detecting a resume event in step S19 on a specific cycle. In this case, the media processing device 1 remains in the second power conservation state, and continues suppressing power supply to power control groups 201 to 203.

While the energizing state of the power control groups 201 and 202 changes when the first power conservation state is entered in step S14 in the example shown in FIG. 4, this could be further split into a level that changes the power supply to the power control group 201 and another level that changes the power supply to the power control group 202. More specifically, the power supply to the power control group 201 could be stopped before entering the first power conservation state, and the CPU 101, which is the power control group 202, could enter the sleep mode when a specific time has past after the power control group 201 turns off. This configuration enables switching the power conservation state of the media processing device 1 more selectively so that, for example, when the CPU 101 stops power supply to the power control group 201 in the normal operating mode, the normal operating mode can be resumed in an extremely short time without reinitializing the CPU 101.

If the CPU 101 detects a resume event after entering the second power conservation state, power supply from the power supply unit 95 to the power control groups 201 to 203 starts (step S20). The FPGA 104 runs the configuration process described above when the power supply to the FPGA 104 starts. As a result, returning from the second power conservation state to the normal mode takes more time than resuming normal operation from the first power conservation state, and the delay time that user must wait to use the media processing device 1 increases. Because the second power conservation state is a deeper power conservation state that the first power conservation state and power consumption is significantly suppressed, the power conservation effect is also great. Recovering from the first power conservation state to the normal operating mode is faster in the first power conservation state, however, and the user does not need to wait as long to resume operation.

The time setting for going from the first power conservation state to the second power conservation state can therefore preferably be optimized for how the media processing device 1 is used, that is, to the broadly defined user environment. The time setting for entering the second power conservation state can therefore be changed in the media processing device 1. The time setting for entering the first power conservation state can also be changed in the media processing device 1.

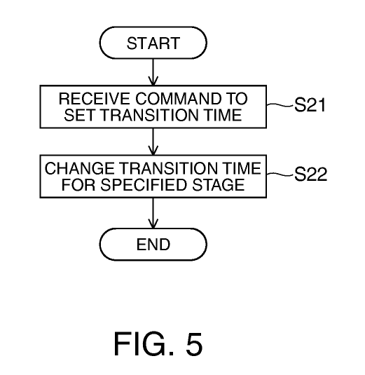

FIG. 5 is a flow chart of media processing device 1 operation, and shows the process for setting or changing the time setting for entering the second power conservation state.

When a command is received from the host computer 5, interpreted, and determined to be a command for setting the mode transition time (step S21), the time setting for entering the power conservation mode set by the received command is updated according to the data contained in the received command (step S22). As a result, the setting stored in the flash ROM 102 is changed, and the settings for entering the first power conservation state and second power conservation state can be changed as desired.

As described above, the media processing device 1 according to this embodiment of the invention has a CPU 101 and a FPGA 104 as a plurality of control devices; at least one control device includes a CPU (CPU 101), at least one other control device includes a programmable device (FPGA 104) that requires configuration at least when the power is turned on; the CPU 101 applies power conservation control that switches the FPGA 104 and another control device, that is, the CPU 101, in stages to a sleep mode based on a specific condition; and can change at least the transition time set for stopping the power supply to the FPGA 104 by power conservation control after the foregoing specific condition is met.

As a result, power consumption when idle can be suppressed by entering a first power conservation state and second power conservation state, and putting the CPU 101 and FPGA 104 to sleep, based on specific conditions such as not receiving data from the host computer 5 for a specific time, or passage of a specific amount of time after an operation that processes checks 4 or other media ends.

In addition, because stopping the power supply to the FPGA 104 that requires configuration, and switching the CPU 101 to the sleep mode, occur in stages, the FPGA 104 can be put to sleep later than the CPU 101, for example, the likelihood of receiving data from the host computer 5 before the FPGA 104 goes to sleep can be increased, and the frequency that the FPGA 104 goes to sleep can be reduced. The need to wait for configuration when the FPGA 104 resumes operation can therefore be reduced, the media processing device 1 can resume from the power conservation state more quickly, and power consumption can be reduced without reducing convenience.

The CPU 101 stops supplying power to the FPGA 104 when sleeping while power is supplied intermittently to control devices other than the FPGA 104, such as the CPU 101, or power is supplied only to selected circuit modules of the CPU 101. As a result, the CPU 101, which is the target of power conservation control, can control returning the FPGA 104 to normal operation after the CPU 101 resumes operation from the sleep mode. Power consumption can also be suppressed because power supply to the FPGA 104 is reduced in steps in the sleep mode.

Furthermore, because the media processing device 1 has an interface unit 76 that can connect to the host computer 5, and the CPU 101 can change the transition time used in power conservation control for switching the FPGA 104 to the second power conservation state after the specific condition is met according to a command received from the host computer 5. As a result, the time setting for entering the second power conservation state can be set or changed, and how frequently the FPGA 104 goes to sleep, or more specifically how frequently configuration of the FPGA 104 is required, can be adjusted. The balance between suppressing power consumption and the time required to recover from the second power conservation state can therefore be easily optimized to how the media processing device 1 is used, and convenience can be improved.

Furthermore, because the CPU 101 of the media processing device 1 changes the power conservation state in plural stages, including a first power conservation state that puts the CPU 101 to sleep and a second power conservation state that stops power supply to the FPGA 104, the stage at which the power supply to the FPGA 104 stops can be clearly controlled separately from when the CPU 101 enters the sleep mode. As a result, the condition (such as the transition time) for stopping the power supply to the FPGA 104 can be set separately from the condition (such as the transition time) for the CPU 101 going to sleep, and how frequently configuration is required can be adjusted as desired.

The media processing device 1 has a conveyance unit that conveys roll paper 3 and a conveyance unit that conveys checks 4 as process media, is configured so that one conveyance unit operates as controlled by a FPGA 104, and the CPU 101 can stop power supply to the power control group 203 including the foregoing conveyance units before the CPU 101 goes to sleep in the first power conservation state. In this case, by providing a stage for stopping power supply to processing units such as the conveyance unit that conveys roll paper 3, the conveyance unit that conveys checks 4, the MICR head 35 (reading unit) or the front CIS unit 47 (reading unit) and back CIS unit 48 (reading unit) that read information on the conveyed checks 4, and the inkjet head 10 (recording unit) that prints or records on the conveyed checks 4, in addition to the stage for stopping power consumption to the FPGA 104 and the stage for setting the CPU 101 to the sleep mode, the power supply can be preferentially stopped to processing units that have high current consumption, such as the hold current of the motors used in these processing units, while idle and take little time to resume operation after the power supply stops, power consumption can be further suppressed, and how frequently the FPGA 104 must be configured can be adjusted desirably.

A preferred embodiment of the invention is described above, but the invention is not so limited. For example, a configuration in which the control devices of the media processing device 1 include a CPU 101 and a FPGA 104 as an example of a programmable device that requires configuration is described above, but the invention is not so limited, and can be configured using any device that is broadly defined as a programmable logic device (PLD), including complex programmable logic devices (CPLD), as a control device.

The number of CPUs 101 and programmable devices is also not particularly limited, and configurations having more programmable devices, or a control device other than a programmable device, are also conceivable. The FPGA 104 is also not limited to configurations externally connected to ROM 105, and could load configuration data from internal memory.

At least part of the function units shown in the block diagram in FIG. 3 indicate a functional configuration, all function units do not need to be rendered as discrete hardware devices, and the functions of plural function units can be combined in a single hardware device, or a single function unit can be rendered using plural hardware devices, through the cooperation of software and hardware.

The program run by the CPU of the CPU 101 that executes the operations described above is not limited to being stored in flash ROM 102, and may be stored on a removable recording medium, or stored downloadably on another device connected over a communication line, and the media processing device 1 could download and run the program from the other device. Other aspects of the configuration can also be changed as desired.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A media processing device having a plurality of control devices, wherein:
at least one control device is a CPU;
at least one control device is a programmable device that requires configuration;
the CPU executes a power supply control process that sets the programmable device and the other control device including the CPU in stages to a sleep mode based on a specific condition; and
the CPU can change the transition time of the power supply control process for setting the programmable device to the sleep mode after the specific condition is met.

2. The media processing device described in claim 1, wherein:
a first sleep mode that is applied to the programmable device in the power supply control process is a mode in which the CPU stops supplying power to the programmable device, and
a second sleep mode that is applied to the control device including the CPU other than the programmable device is a mode in which the CPU intermittently supplies power to the control device, or supplies power to one module and does not supply power to another module of the control device.

3. The media processing device described in claim 1, further comprising:
an interface unit that can connect to an external device;
wherein the CPU sets the transition time of the power supply control process for setting the programmable device to the sleep mode after the specific condition is met based on a command received through the interface unit.

4. The media processing device described in claim 1, wherein:
in the power supply control process the CPU changes between a plurality of stages including a first stage that sets the control device including the CPU other than the programmable device to the sleep mode, and a second stage that sets the programmable device to the sleep mode.

5. The media processing device described in claim 4, further comprising:
a plurality of processing units that process media to be processed;
wherein at least one of the processing units operates as controlled by the programmable device; and
in the power supply control process the CPU enters a stage that stops power supply to at least one processing unit before entering the sleep mode of the first stage, and enters the sleep mode of the first stage thereafter.

6. A method of controlling a media processing device having a plurality of control devices including a programmable device that requires configuration and a CPU, the control method comprising steps of:
executing a power supply control process that sets the programmable device and the other control device including the CPU in stages to a sleep mode based on a specific condition; and
changing the transition time for setting the programmable device to the sleep mode after the specific condition is met in the power supply control process.

7. The method of controlling a media processing device described in claim 6, wherein:
in the power supply control process, a first sleep mode that is applied to the programmable device is a mode in which supplying power stops, and
a second sleep mode that is applied to the control device including the CPU other than the programmable device is a mode in which power is supplied intermittently to the control device, or power is supplied to one module and is not supplied to another module of the control device.

8. The method of controlling a media processing device described in claim 6, wherein:
the media processing device can connect to an external device; and
in the power supply control process, the transition time for setting the programmable device to the sleep mode after the specific condition is met is set based on a command received from the external device.

9. The method of controlling a media processing device described in claim 6, wherein:
operation changes in the power supply control process between a plurality of stages including a first stage that sets the control device including the CPU other than the programmable device to the sleep mode, and a second stage that sets the programmable device to the sleep mode.

10. The method of controlling a media processing device described in claim 9, wherein:
the media processing device has a plurality of processing units that process media to be processed, and at least one of the processing units operates as controlled by the programmable device; and
in the power supply control process, a stage that stops power supply to at least one processing unit is entered before entering the sleep mode of the first stage, and the sleep mode of the first stage is entered thereafter.
